(19) United States
(12) Patent Application Publication
(10) Pub. No.: US 2016/0125347 A1
(43) Pub. Date: May 5, 2016

(54) USER SCORES BASED ON BULK RECORD UPDATES

(71) Applicant: salesforce.com, inc., San Francisco, CA (US)

(72) Inventors: Arun Kumar Jagota, Sunnyvale, CA (US); Gregory Haardt, San Carlos, CA (US); Matthew Fuchs, Los Gatos, CA (US)

(21) Appl. No.: 14/532,179

(22) Filed: Nov. 4, 2014

(51) Int. Cl. G06Q 10/06; G06F 17/30

(52) U.S. Cl. CPC G06Q 10/06398; G06F 17/30554

(57) ABSTRACT

User scores based on bulk record updates is described. A system receives record updates submitted by a user. The system subtracts a penalty debit from a user score, which corresponds to the user, for each record which corresponds to at least one of the record updates and which is removed from purchasing availability. The system adds a full credit to the user score for each record which corresponds to at least one of the record updates and which is purchased. The system adds a partial credit to the user score for each record which corresponds to at least one of the record updates and which is yet to be purchased and which is yet to be removed from purchasing availability, wherein the partial credit is a positive value that is less than the full credit. The system enables the user to access records, based on the user score.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Some database users provide many record updates, such as adding and updating business contact records. A database system may reward a user who updated a record by adding credit to the updating user's score if the record is subsequently purchased, and may penalize the user by subtracting credit from the updating user's score if the record is made unavailable for purchasing due to bad data in the record, which may be referred to as grave-yarding. The database system may use the user's score to determine the user's level of access to the database system, such as enabling the user to update business contact records if the user's score is sufficiently high. Users may earn credits by providing good record updates, and use these credits to purchase records or otherwise access the database system.

While a user may carefully evaluate individual record updates for accuracy before submission to the database system, the user may not have time to evaluate all of the record updates in a bulk submission of record updates for accuracy, and many database systems may receive most of their record updates through bulk submissions. However, such a scoring system may initially over-penalize bulk record updates because a database system may be able to immediately identify bad business contact records using an email verifier, resulting in an immediate penalty for the submitting user, while providing a reward for the submitting user which is delayed due to having to wait some amount of time before a user-updated business contact record is subsequently purchased, thereby resulting in a user score that is initially more negative than the user score will ultimately become. During this initial period of time when the user score is more negative then it will later become, the lower user score may prevent the submitting user from being able to fully access the database system, thereby providing a disincentive for the user to provide bulk submissions.

### BRIEF SUMMARY

In accordance with embodiments, there are provided systems and methods for user scores based on bulk record updates. Record updates, which are submitted by a user, are received. A penalty debit is subtracted from a user score, which corresponds to the user, for each record which corresponds to at least one of the record updates and which is removed from purchasing availability. A full credit is added to the user score for each record which corresponds to at least one of the record updates and which is purchased. A partial credit is added to the user score for each record which corresponds to at least one of the record updates and which is yet to be purchased and which is yet to be removed from purchasing availability, wherein the partial credit is a positive value that is less than the full credit. The user is enabled to access records, based on the user score.

For example, a system receives 100 record updates submitted by a user. The system subtracts 9 points from the user's score for the 9 updated records, corresponding to 9 record updates submitted by the user, which the system grave-yards because the system automatically identifies these 9 updated records as bad records using an email verifier. The system does not add any full points to the user's score yet because the 91 records updated by the remaining 91 record updates have not been available for purchase long enough since the 91 updates occurred for any other users to purchase any of these 91 updated records. The system adds 0.1 points to the user's score for each of the 91 records corresponding to the 91 record updates which have not yet resulted in a grave-yarded record or a purchased record, which results in the system adding 9.1 points to the user's score. The 9.1 positive points more than offsets the 9.0 negative points for the 9 grave-yarded records, such that the system enables the user to access records, based on the user's score, which was not over-penalized for the 9 grave-yarded records because of the 91 updated records that may be purchased.

While one or more implementations and techniques are described with reference to an embodiment in which user scores based on bulk record updates is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for user scores based on bulk record updates, in an embodiment;

FIG. 2 is a block diagram of an example data structure for user scores based on bulk record updates, in an embodiment;

FIG. 3 illustrates a block diagram of an example of an environment wherein an on-demand database service might be used; and

FIG. 4 illustrates a block diagram of an embodiment of elements of FIG. 3 and various possible interconnections between these elements.

### DETAILED DESCRIPTION

### General Overview

Systems and methods are provided for user scores based on bulk record updates. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system. Next, mechanisms and methods for user scores based on bulk record updates will be described with reference to example embodiments. The following detailed description will first describe a method for user scores based on bulk record updates. Next, a block diagram of a data structure for user scores based on bulk record updates is described.

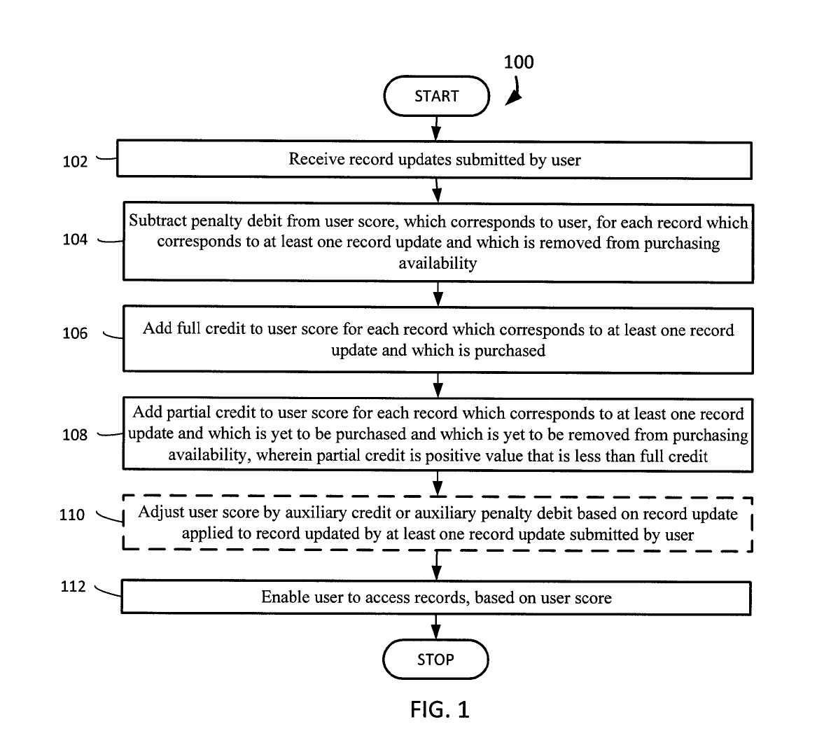

FIG. 1 is an operational flow diagram illustrating a high level overview of a method 100 for user scores based on bulk record updates. As shown in FIG. 1, a database system may calculate and apply user scores based on bulk record updates.

A database system receives record updates submitted by a user, block 102. For example and without limitation, this can include the database system receiving 100 record updates submitted by a user. A user-submitted record update either creates, modifies, or deletes data in a record's fields, such as the first name, the last name, the company name, and the industry for a business contact record. The database system may not calculate a user score for a user until after the user has submitted at least 10 record updates, thereby avoiding large swings in the user score until the database system has enough record updates for evaluation as the basis for a more stable user score.

Having received multiple record updates from a user, the database system subtracts a penalty debit from a user score, which corresponds to the user, for each record which corresponds to at least one of the record updates and which is removed from purchasing availability, block 104. By way of example and without limitation, this can include the database system subtracting 9 points from the user's score for the 9 updated records, corresponding to 9 record updates submitted by the user, which the database system grave-yards because the database system automatically identifies these 9 updated record as bad records using an email verifier, such as Brite Verify®.

In another example, the database system automatically identifies some updated records, corresponding to user-submitted record updates, as bad records because these user-submitted update add unnecessary punctuation. The penalty debit may be adjusted based on a time decay factor because the earlier in time that a record is grave-yarded, the more likely that the data in the corresponding record update was initially bad. For example, the database system subtracts only 0.5 points from the user's score for a record which corresponds to a record update submitted by the user which the system grave-yards one month after the user submitted the record update because another user identifies the updated record as including data that is no longer valid.

Although an example of a time decay factor is described, another method may be used to adjust the user score based on the amount of time delay that occurs before the database system provides a further adjustment to the user score. The penalty debit may be adjusted based on the number of records updated by the user's record updates which are subsequently grave-yarded. For example, the database system may give the user the benefit of the doubt by not subtracting any points from the user's score for first 9 grave-yarded records, may subtract 1.0 points from the user's score for each of the 10^{th} through 99^{th} grave-yarded records, and may subtract 2.0 points from the user's score for each additional grave-yarded record.

Having adjusted the user score for any required penalty debits, the database system adds a full credit to the user score for each record which corresponds to at least one of the record updates and which is purchased, block 106. In embodiments, this can include the database system not adding any full points to the user's score yet because the 91 records updated by the remaining 91 record updates have not been available for purchase long enough since the 91 updates occurred for any other users to purchase any of these 91 updated records. Business contact records that are purchased by system users can be considered as good data records produced because a purchasing user is likely to complain to a system administrator if a business contact record includes bad data. Some of the user's record updates will be eventually evaluated by other users, such as when other users purchase business contact records updated by the user's record updates or when other users grave-yard business contact records updated by the user's record updates, whereby the database system further adjusts the user score over time.

The full credit may be added to the user score based every instance when a corresponding record is purchased or based on a first instance when a corresponding record is purchased, and the full credit may be adjusted based on a time decay factor. For example, the database system adds 70% of a full point to the user's score for a business contact record that is updated by the user's record updates and then purchased by another user three months later. Although an example of a time decay factor is described, another method may be used to adjust the user score based on the amount of time delay that occurs before the database system provides a further adjustment to the user score.

After adding any required full credits to the user score, the database system adds a partial credit to the user score for each record which corresponds to at least one of the record updates and which is yet to be purchased and which is yet to be removed from purchasing availability, wherein the partial credit is a positive value that is less than the full credit, block 108. For example and without limitation, this can include the database system adding 0.1 points to the user's score for each of the 91 records corresponding to the 91 record updates which have not yet resulted in a grave-yarded record or a purchased record, which results in the database system adding 9.1 points to the user's score. The 9.1 positive points more than offsets the 9.0 negative points for the 9 grave-yarded records, thereby providing incentive for the user to provide the database system with bulk record updates which the user did not have time to individually evaluate for accuracy.

In another example, the database system adds 0.2 points to the user score because one of the user's record updates provided a phone number and an email address for a business contact, and this type of information is especially important to users who may purchase the updated record. However, if the update of the phone number and the email address is followed by another user providing another record update which corrects the business contact's updated phone number and email address, the database system may adjust the initial user's score by a penalty debit for providing incorrect information.

The ratio of the partial credit to the penalty debit may be based on an administrator specified percentage of record updates in the record updates which correspond to records removed from purchasing availability. For example, if a system administrator is willing to accept 9% bad record updates, the system administrator assigns 1.0 penalty debit point for each updated record which is grave-yarded and which corresponds to a record update and assigns the partial credit of 0.1 point to each record update which corresponds to records that are neither grave-yarded nor purchased, such that the database system assigns the positive 0.1 points to the user score when 9% of the 100 updated record are bad.

The penalty debit (d), the full credit (f), and/or the partial credit (p) may be adjusted based on a number of corresponding record updates. For example, a system administrator may generalize the parameters d, f, and p to d(n), f(n), and p(n), where n is the number of record updates in a bulk file submission. A single record update can be treated as a special case, with n=1. Each of d(n), f(n), and p(n) can be modeled as exponential, or geometric, decays of the three parameters d(1), f(1), and p(1), respectively, with increasing n. This way, this new model is more expressive than the older model, without being more complex, as the new model still has three parameters. The reason behind this variation is rewards or penalties on individual record update coming from a bulk submission may be less for large bulk submissions and more for small bulk submissions.

Having adjusted the user score based on the bulk record updates submitted by the user, the database system may optionally adjust the user score by an auxiliary credit or an auxiliary penalty debit based on a record update applied to a record updated by at least one record update submitted by the user, block 110. By way of example and without limitation, this can include the database system adding 1.0 points to the user score for a first user because after a second user grave-yarded a record provided by the first user and the database system responded by subtracting 1.0 points from the first user's score, the first user reactivated the record, thereby implying that the second user was incorrect in grave-yarding the record. If two users disagree about data in a record, the database system may treat both users' actions neutrally, instead of arbitrating which user is correct and having to respond to any subsequent appels.

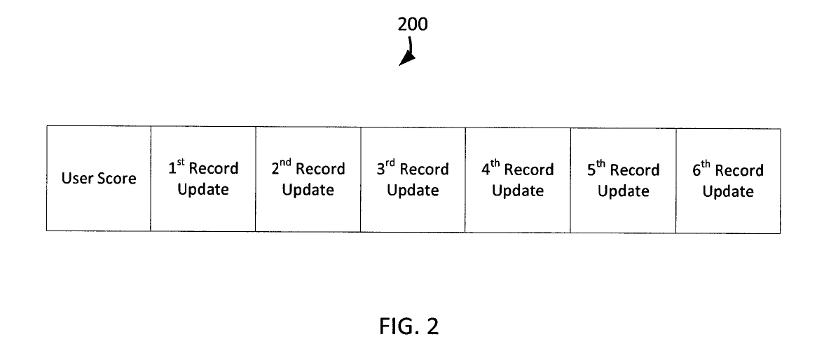

Removing the prior penalty debit from the user score encourages the first user to pay attention to her updated records and keep these records up to date. However, if the first user did not respond to the second user grave-yarding the record by reactivating the record, the database system does not adjust the first user's score by adding 1.0 points because the database system interprets the lack of a response from the first user as an admission that the second user was correct in grave-yarding the record, such that the database system may add 1.0 points to the second user's score for grave-yarding bad data. A block diagram of an example data structure for user scores based on bulk record updates is depicted in FIG. 2 and described below in the description of FIG. 2.

Having adjusted the user score based on the bulk record updates submitted by the user, and possibly further adjusted the user score, the database system enables the user to access records, based on the user score, block 112. In embodiments, this can include the database system enabling the user to access records, based on the user's score, which was not over-penalized for the 9 grave-yarded records in light of the 91 updated records that may be purchased. Although the previous examples describe record updates for a business contact record, the same principles apply to records updates for company records.

The method 100 may be repeated as desired. Although this disclosure describes the blocks 102-112 executing in a particular order, the blocks 102-112 may be executed in a different order. In other implementations, each of the blocks 102-112 may also be executed in combination with other blocks and/or some blocks may be divided into a different set of blocks.

FIG. 2 illustrates a block diagram of an example data structure 200 for user scores based on bulk record updates, under an embodiment. The data structure 200 includes a user score, which the database system calculates based on the user's 100 record updates, and the first 6 of the 100 record updates. If the database system identifies too many of the record updates as corresponding to updated records that should be grave-yarded, the database system may calculate a user′ score which is below an access threshold, such that the database system may not permit the user to update any of the records corresponding to the user's 100 record updates.

### System Overview

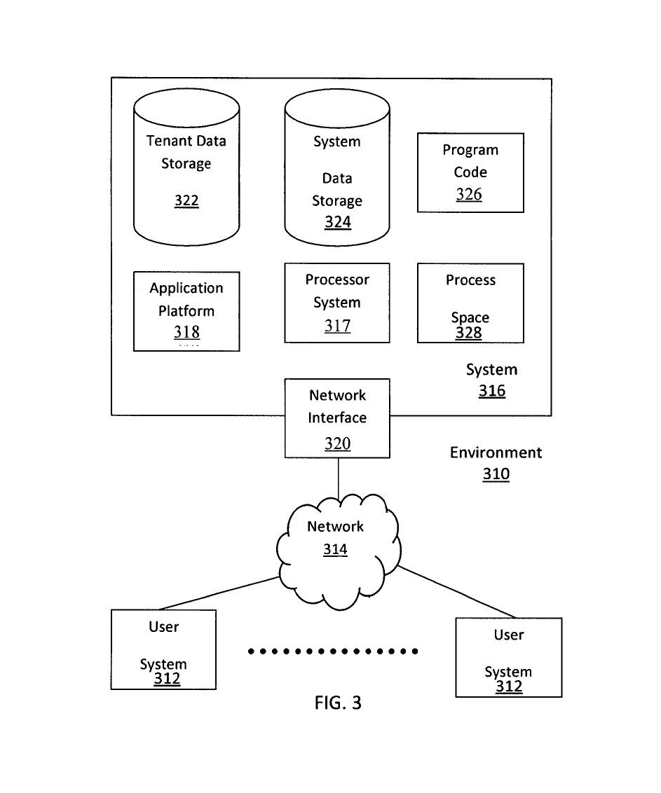

FIG. 3 illustrates a block diagram of an environment 310 wherein an on-demand database service might be used. The environment 310 may include user systems 312, a network 314, a system 316, a processor system 317, an application platform 318, a network interface 320, a tenant data storage 322, a system data storage 324, program code 326, and a process space 328. In other embodiments, the environment 310 may not have all of the components listed and/or may have other elements instead of, or in addition to, those listed above.

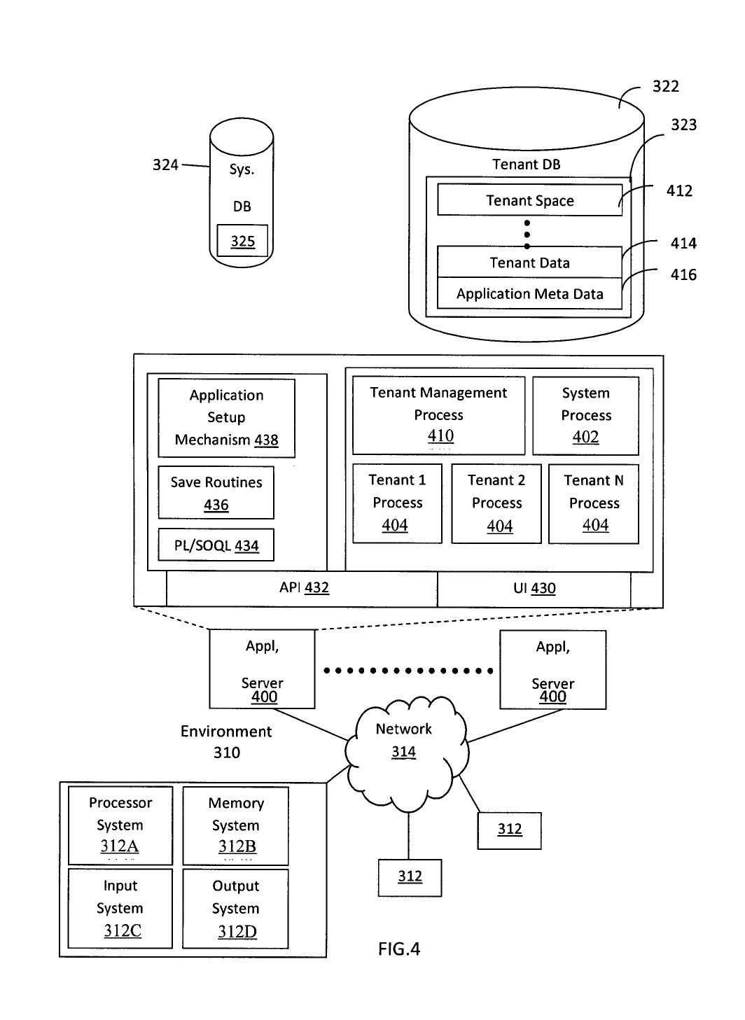

The environment 310 is an environment in which an on-demand database service exists. A user system 312 may be any machine or system that is used by a user to access a database user system. For example, any of the user systems 312 may be a handheld computing device, a mobile phone, a laptop computer, a work station, and/or a network of computing devices. As illustrated in FIG. 3 (and in more detail in FIG. 4) the user systems 312 might interact via the network 314 with an on-demand database service, which is the system 316.

An on-demand database service, such as the system 316, is a database system that is made available to outside users that do not need to necessarily be concerned with building and/or maintaining the database system, but instead may be available for their on-demand database services may store information from one or more tenants stored into tables of a common database image to form a multi-tenant database system (MTS). Accordingly, the “on-demand database service 316” and the “system 316” will be used interchangeably herein. A database image may include one or more database objects. A relational database management system (RDMS) or the equivalent may execute storage and retrieval of information against the database object(s). The application platform 318 may be a framework that allows the applications of the system 316 to run, such as the hardware and/or software, e.g., the operating system. In an embodiment, the on-demand database service 316 may include the application platform 318 which enables creation, managing and executing one or more applications developed by the provider of the on-demand database service, users accessing the on-demand database service via user systems 312, or third party application developers accessing the on-demand database service via the user systems 312.

The users of the user systems 312 may differ in their respective capacities, and the capacity of a particular user system 312 might be entirely determined by permissions (permission levels) for the current user. For example, where a salesperson is using a particular user system 312 to interact with the system 316, that user system 312 has the capacities allotted to that salesperson. However, while an administrator is using that user system 312 to interact with the system 316, that user system 312 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 314 is any network or combination of networks of devices that communicate with one another. For example, the network 314 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 312 might communicate with the system 316 using TCP/IP and, at a higher network level, use other common Internet protocols to communicate, such as HTTP, FTP, AFS, WAP, etc. In an example where HTTP is used, the user systems 312 might include an HTTP client commonly referred to as a “browser” for sending and receiving HTTP messages to and from an HTTP server at the system 316. Such an HTTP server might be implemented as the sole network interface between the system 316 and the network 314, but other techniques might be used as well or instead. In some implementations, the interface between the system 316 and the network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 316, shown in FIG. 3, implements a web-based customer relationship management (CRM) system. For example, in one embodiment, the system 316 includes application servers configured to implement and execute CRM software applications as well as provide related data, code, forms, webpages and other information to and from the user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, the system 316 implements applications other than, or in addition to, a CRM application. For example, the system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of the system 316 is shown in FIG. 3, including the network interface 320, the application platform 318, the tenant data storage 322 for tenant data 323, the system data storage 324 for system data 325 accessible to the system 316 and possibly multiple tenants, the program code 326 for implementing various functions of the system 316, and the process space 328 for executing MTS system processes and tenant-specific processes, such as running applications as part of an application hosting service. Additional processes that may execute on the system 316 include database indexing processes.

Several elements in the system shown in FIG. 3 include conventional, well-known elements that are explained only briefly here. For example, each of the user systems 312 could include a desktop personal computer, workstation, laptop, PDA, cell phone, or any wireless access protocol (WAP) enabled device or any other computing device capable of interfacing directly or indirectly to the Internet or other network connection. Each of the user systems 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 312 to access, process and view information, pages and applications available to it from the system 316 over the network 314. Each of the user systems 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by the system 316 or other systems or servers. For example, the user interface device may be used to access data and applications hosted by the system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of the user systems 312 and all of its components are operator configurable using applications, such as a browser, including computer code run using a central processing unit such as an Intel Pentium® processor or the like. Similarly, the system 316 (and additional instances of an MTS, where more than one is present) and all of their components might be operator configurable using application(s) including computer code to run using a central processing unit such as the processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring the system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 316 is configured to provide webpages, forms, applications, data and media content to the user (client) systems 312 to support the access by the user systems 312 as tenants of the system 316. As such, the system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates the environment 310. However, in FIG. 4 elements of the system 316 and various interconnections in an embodiment are further illustrated. FIG. 4 shows that the each of the user systems 312 may include a processor system 312A, a memory system 312B, an input system 312C, and an output system 312D. FIG. 4 shows the network 314 and the system 316. FIG. 4 also shows that the system 316 may include the tenant data storage 322, the tenant data 323, the system data storage 324, the system data 325, a User Interface (UI) 430, an Application Program Interface (API) 432, a PL/SOQL 434, save routines 436, an application setup mechanism 438, applications servers 4001-400N, a system process space 402, tenant process spaces 404, a tenant management process space 410, a tenant storage area 412, a user storage 414, and application metadata 416. In other embodiments, the environment 310 may not have the same elements as those listed above and/or may have other elements instead of, or in addition to, those listed above.

The user systems 312, the network 314, the system 316, the tenant data storage 322, and the system data storage 324 were discussed above in FIG. 3. Regarding the user systems 312, the processor system 312A may be any combination of one or more processors. The memory system 312B may be any combination of one or more memory devices, short term, and/or long term memory. The input system 312C may be any combination of input devices, such as one or more keyboards, mice, trackballs, scanners, cameras, and/or interfaces to networks. The output system 312D may be any combination of output devices, such as one or more monitors, printers, and/or interfaces to networks. As shown by FIG. 4, the system 316 may include the network interface 320 (of FIG. 3) implemented as a set of HTTP application servers 400, the application platform 318, the tenant data storage 322, and the system data storage 324. Also shown is the system process space 402, including individual tenant process spaces 404 and the tenant management process space 410. Each application server 400 may be configured to access tenant data storage 322 and the tenant data 323 therein, and the system data storage 324 and the system data 325 therein to serve requests of the user systems 312. The tenant data 323 might be divided into individual tenant storage areas 412, which can be either a physical arrangement and/or a logical arrangement of data. Within each tenant storage area 412, the user storage 414 and the application metadata 416 might be similarly allocated for each user. For example, a copy of a user's most recently used (MRU) items might be stored to the user storage 414. Similarly, a copy of MRU items for an entire organization that is a tenant might be stored to the tenant storage area 412. The UI 430 provides a user interface and the API 432 provides an application programmer interface to the system 316 resident processes to users and/or developers at the user systems 312. The tenant data and the system data may be stored in various databases, such as one or more Oracle™ databases.

The application platform 318 includes the application setup mechanism 438 that supports application developers' creation and management of applications, which may be saved as metadata into the tenant data storage 322 by the save routines 436 for execution by subscribers as one or more tenant process spaces 404 managed by the tenant management process 410 for example. Invocations to such applications may be coded using the PL/SOQL 434 that provides a programming language style interface extension to the API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 416 for the subscriber making the invocation and executing the metadata as an application in a virtual machine.

Each application server 400 may be communicably coupled to database systems, e.g., having access to the system data 325 and the tenant data 323, via a different network connection. For example, one application server 4001 might be coupled via the network 314 (e.g., the Internet), another application server 400N-1 might be coupled via a direct network link, and another application server 400N might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, the system 316 is multi-tenant, wherein the system 316 handles storage of, and access to, different objects, data and applications across disparate users and organizations.

As an example of storage, one tenant might be a company that employs a sales force where each salesperson uses the system 316 to manage their sales process. Thus, a user might maintain contact data, leads data, customer follow-up data, performance data, goals and progress data, etc., all applicable to that user's personal sales process (e.g., in the tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, the system 316 might also maintain system level data usable by multiple tenants or other data. Such system level data might include industry reports, news, postings, and the like that are sharable among tenants.

In certain embodiments, the user systems 312 (which may be client systems) communicate with the application servers 400 to request and update system-level and tenant-level data from the system 316 that may require sending one or more queries to the tenant data storage 322 and/or the system data storage 324. The system 316 (e.g., an application server 400 in the system 316) automatically generates one or more SQL statements (e.g., one or more SQL queries) that are designed to access the desired information. The system data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for user scores based on bulk record updates, the apparatus comprising:
one or more processors; and
a non-transitory computer readable medium storing a plurality of instructions, which when executed, cause the one or more processors to:
receive a plurality of record updates submitted by a user;
subtract a penalty debit from a user score, which corresponds to the user, for each record which corresponds to at least one of the plurality of record updates and which is removed from purchasing availability;
add a full credit to the user score for each record which corresponds to at least one of the plurality of record updates and which is purchased;
add a partial credit to the user score for each record which corresponds to at least one of the plurality of record updates and which is yet to be purchased and which is yet to be removed from purchasing availability, wherein the partial credit is a positive value that is less than the full credit; and
enable the user to access records, based on the user score.

2. The system of claim 1, wherein each record comprises at least one field, and wherein the plurality of record updates comprises at least one of a field creation, a field modification, and a field deletion.

3. The system of claim 1, wherein at least one of the penalty debit and the full credit is adjusted based on a time decay factor.

4. The system of claim 1, wherein the full credit is added to the user score based on one of every instance when a corresponding record is purchased and a first instance when a corresponding record is purchased.

5. The system of claim 1, wherein a ratio of the partial credit to the penalty debit is based on an administrator specified percentage of record updates in the plurality of record updates which correspond to records removed from purchasing availability.

6. The system of claim 1, comprising further instructions, which when executed, cause the one or more processors to adjust the user score by one of an auxiliary credit and an auxiliary penalty debit based on a record update applied to a record updated by at least one of the plurality of record updates submitted by the user.

7. The system of claim 1, wherein at least one of the penalty debit, the full credit, and the partial credit is adjusted based on a number of corresponding record updates.

8. A computer program product comprising computer-readable program code to be executed by one or more processors when retrieved from a non-transitory computer-readable medium, the program code including instructions to:
receive a plurality of record updates submitted by a user;
subtract a penalty debit from a user score, which corresponds to the user, for each record which corresponds to at least one of the plurality of record updates and which is removed from purchasing availability;
add a full credit to the user score for each record which corresponds to at least one of the plurality of record updates and which is purchased;
add a partial credit to the user score for each record which corresponds to at least one of the plurality of record updates and which is yet to be purchased and which is yet to be removed from purchasing availability, wherein the partial credit is a positive value that is less than the full credit; and
enable the user to access records, based on the user score.

9. The computer program product of claim 8, wherein each record comprises at least one field, and wherein the plurality of record updates comprises at least one of a field creation, a field modification, and a field deletion.

10. The computer program product of claim 8, wherein at least one of the penalty debit and the full credit is adjusted based on a time decay factor.

11. The computer program product of claim 8, wherein the full credit is added to the user score based on one of every instance when a corresponding record is purchased and a first instance when a corresponding record is purchased.

12. The computer program product of claim 8, wherein a ratio of the partial credit to the penalty debit is based on an administrator specified percentage of record updates in the plurality of record updates which correspond to records removed from purchasing availability.

13. The computer program product of claim 8, wherein the program code comprises further instructions to adjust the user score by one of an auxiliary credit and an auxiliary penalty debit based on a record update applied to a record updated by at least one of the plurality of record updates submitted by the user

14. The computer program product of claim 8, wherein at least one of the penalty debit, the full credit, and the partial credit is adjusted based on a number of corresponding record updates.

15. A method for user scores based on bulk record updates, the method comprising:
receiving a plurality of record updates submitted by a user;
subtracting a penalty debit from a user score, which corresponds to the user, for each record which corresponds to at least one of the plurality of record updates and which is removed from purchasing availability;
adding a full credit to the user score for each record which corresponds to at least one of the plurality of record updates and which is purchased;
adding a partial credit to the user score for each record which corresponds to at least one of the plurality of record updates and which is yet to be purchased and which is yet to be removed from purchasing availability, wherein the partial credit is a positive value that is less than the full credit; and
enabling the user to access records, based on the user score.

16. The method of claim 15, wherein each record comprises at least one field, and wherein the plurality of record updates comprises at least one of a field creation, a field modification, and a field deletion.

17. The method of claim 15, wherein at least one of the penalty debit and the full credit is adjusted based on a time decay factor.

18. The method of claim 15, wherein the full credit is added to the user score based on one of every instance when a corresponding record is purchased and a first instance when a corresponding record is purchased.

19. The method of claim 15, wherein a ratio of the partial credit to the penalty debit is based on an administrator specified percentage of record updates in the plurality of record updates which correspond to records removed from purchasing availability.

20. The method of claim 15, the method further comprising adjusting the user score by one of an auxiliary credit and an auxiliary penalty debit based on a record update applied to a record updated by at least one of the plurality of record updates submitted by the user
